(19) United States
(12) Patent Application Publication
(10) Pub. No.: US 2026/0368594 A1
(43) Pub. Date: Nov. 19, 2026

(54) APPARATUS AND METHOD FOR QUANTUM COMMUNICATION USING GHOST IMAGES

(71) Applicant: KOREA AEROSPACE RESEARCH INSTITUTE, Daejeon (KR)

(72) Inventor: Hwan-chun MYUNG, Daejeon (KR)

(21) Appl. No.: 19/677,437

(22) Filed: May 14, 2026

(30) Foreign Application Priority Data
May 19, 2025 (KR) 10-2025-0064732

(51) Int. Cl. G06N 10/40

(52) U.S. Cl. CPC G06N 10/40

(57) ABSTRACT

A quantum communication apparatus includes a transmitter configured to generate a pair of photons in a quantum entangled state, the pair of photons being a signal photon and an idler photon, transmit the signal photon through a signal path, transmit the idler photon through an idler path, and detect a detection position of the idler photon, a receiver configured to receive the signal photon transmitted through the signal path and detect a detection position of the signal photon, and a controller configured to perform quantum communication based on detection position data of the idler photon and detection position data of the signal photon.

### CROSS-REFERENCE TO RELATED APPLICATION

This application is based on and claims priority under 35 U.S.C. §119 to Korean Patent Application No. 10-2025-0064732, filed on May 19, 2025, in the Ministry of Intellectual Property, Republic of Korea, the disclosure of which is incorporated by reference herein in its entirety.

### BACKGROUND

### 1. Field

The disclosure relates to a quantum communication apparatus and method using ghost images.

### 2. Description of the Related Art

Ghost images have been experimentally verified, and FIGS. 1 and 2 illustrate a conceptual diagram of a ghost image experiment environment and an example of an optical path of a ghost image. Referring to FIG. 1, after two generated entangled photons split from each other and proceed respectively through a signal path and an idler path, a photon of the signal path is detected by a detector D1 based on a pattern located in an aperture, and a photon of the idler path is correlated with the position of an aperture pattern reached by a signal photon and is detected by a detector D2 at a synchronized corresponding position. The information measured by the detectors D1 and D2 is analyzed together at N2 to derive specific image position information of the pattern.

As such, the fact that position information of a photon reaching a specific position of an observation target (located in a signal path) may be identified through a ghost image in an idler path without the observation target may provide the feature of being able to separately observe light source intensity information and position information when obtaining an image of the observation target, and furthermore, the fact that each of the photons maintains a quantum entangled state may provide the advantage of being able to secure high observation sensitivity of the observation target by using a single photon. Research on existing ghost imaging technologies has mainly focused on overcoming various problems in the field of image observation by using the entanglement properties of photons.

### SUMMARY

Provided are a quantum communication apparatus and method using ghost images by applying the ghost imaging technology to the field of information and communication. However, these problems are merely examples and the scope of the disclosure is not limited thereto.

Additional aspects will be set forth in part in the description which follows and, in part, will be apparent from the description, or may be learned by practice of the presented embodiments of the disclosure.

According to an aspect of the disclosure, a quantum communication apparatus includes a transmitter configured to generate a pair of photons in a quantum entangled state, the pair of photons being a signal photon and an idler photon, transmit the signal photon through a signal path, transmit the idler photon through an idler path, and detect a detection position of the idler photon, a receiver configured to receive the signal photon transmitted through the signal path and detect a detection position of the signal photon, and a controller configured to perform quantum communication based on detection position data of the idler photon and detection position data of the signal photon.

The transmitter may include a photon generator configured to generate the signal photon and the idler photon by using a single photon, a beam splitter configured to split the signal photon and the idler photon into a signal path and an idler path respectively, a first charge-coupled device (CCD) sensor configured to detect a detection position of the idler photon transmitted through the idler path, and a lens optical unit configured to form the signal path such that the signal photon of the signal path is collected by the receiver.

The receiver may include a second CCD sensor configured to detect the detection position of the signal photon transmitted through the signal path.

The controller may be configured to perform quantum communication based on pattern information of detection position data detected by the first CCD sensor and the second CCD sensor and cryptographic key information corresponding to the pattern information.

The controller may be configured to have a first delay time between photon transmissions in a case of normal reception of photons according to the pattern information and the cryptographic key information, have a second delay time between photon transmissions in a case of abnormal reception of photons, and have a third delay time between photon transmissions in a case of termination of transmission of photons.

According to another aspect of the disclosure, a quantum communication method includes a transmission operation of generating a pair of photons in a quantum entangled state, the pair of photons being a signal photon and an idler photon, transmitting the signal photon through a signal path, transmitting the idler photon through an idler path, and detecting a detection position of the idler photon, a reception operation of receiving the signal photon transmitted through the signal path and detecting a detection position of the signal photon, and an operation of performing quantum communication based on detection position data of the idler photon and detection position data of the signal photon.

The transmission operation may include an operation of generating a signal photon and an idler photon by using a single photon, an operation of splitting the signal photon and the idler photon into a signal path and an idler path respectively, an operation of detecting a detection position of the idler photon transmitted through the idler path, by using a first CCD sensor, and an operation of forming the signal path such that the signal photon is collected.

The reception operation may include an operation of detecting the detection position of the signal photon transmitted through the signal path, by using a second CCD sensor.

The operation of performing quantum communication may include an operation of performing quantum communication based on pattern information of detection position data detected by the first CCD sensor and the second CCD sensor and cryptographic key information corresponding to the pattern information.

The operation of performing quantum communication may include an operation of having a first delay time between photon transmissions in a case of normal reception of photons according to the pattern information and the cryptographic key information, an operation of having a second delay time between photon transmissions in a case of abnormal reception of photons, and an operation of having a third delay time between photon transmissions in a case of termination of transmission of photons.

According to another aspect of the disclosure, a computer program is stored in a recording medium to execute the above quantum communication method by using a computer.

Other aspects, features, and advantages other than those described above will become apparent from the following detailed description, the appended claims, and the accompanying drawings.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 and 2 illustrate a conceptual diagram of a ghost image verification experiment and an example of an optical path of a ghost image;

FIG. 3 illustrates a configuration and operation of a quantum communication apparatus using ghost images, according to an embodiment;

FIG. 4 is a flowchart illustrating a quantum communication method according to an embodiment;

FIG. 5 illustrates a quantum cryptographic key generation method according to an embodiment;

FIG. 6 illustrates a matching relationship between a quantum cryptographic pattern and a charge-coupled device (CCD) data map, according to an embodiment; and

FIG. 7 illustrates an example of a quantum communication method according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term "and/or" includes any and all combinations of one or more of the associated listed items. Expressions such as "at least one of," when preceding a list of elements, modify the entire list of elements and do not modify the individual elements of the list.

The disclosure may include various embodiments and modifications, and certain embodiments thereof are illustrated in the drawings and will be described herein in detail. The advantages and features of the disclosure and the accomplishing methods thereof will become apparent from the embodiments described below in detail with reference to the accompanying drawings. However, the disclosure is not limited to the embodiments described below, and may be embodied in various modes.

Hereinafter, embodiments of the disclosure will be described in detail with reference to the accompanying drawings, and in the following description, like reference numerals will denote like elements and redundant descriptions thereof will be omitted.

It will be understood that although terms such as "first" and "second" may be used herein to describe various elements, these elements should not be limited by these terms and these terms are only used to distinguish one element from another element. Also, as used herein, the singular forms "a", "an", and "the" are intended to include the plural forms as well, unless the context clearly indicates otherwise. Also, it will be understood that the terms "comprise," "include," and "have" used herein specify the presence of stated features or components, but do not preclude the presence or addition of one or more other features or components.

Sizes of elements in the drawings may be exaggerated for convenience of description. In other words, because the sizes and shapes of components in the drawings are arbitrarily illustrated for convenience of description, the disclosure is not limited thereto.

It will be understood that when an element such as an area, component, unit, block, or module is referred to as being on or over another element, it may be directly on or over the other element or may be indirectly on or over the other element with one or more intervening areas, components, units, blocks, or modules therebetween. Also, when areas, components, units, blocks, or modules are referred to as being connected to each other, the areas, components, units, blocks, or modules may be directly connected to each other or may be indirectly connected to each other with one or more intervening areas, components, units, blocks, or modules therebetween.

Hereinafter, various embodiments will be described in detail with reference to the accompanying drawings so that those of ordinary skill in the art may easily implement the disclosure.

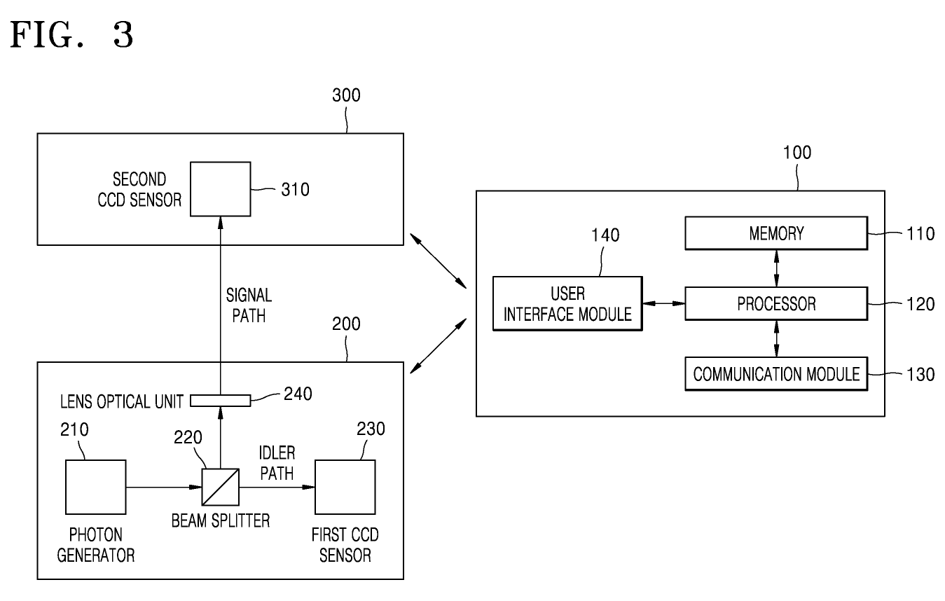

FIG. 3 illustrates a configuration and operation of a quantum communication apparatus using ghost images, according to an embodiment.

Referring to FIG. 3, the quantum communication apparatus according to an embodiment may include a controller 100, a transmitter 200, and a receiver 300. The quantum communication apparatus may further include other components, or some components thereof may be omitted. Each of some components of the quantum communication apparatus may be divided into a plurality of devices, or a plurality of components may be combined into a single device.

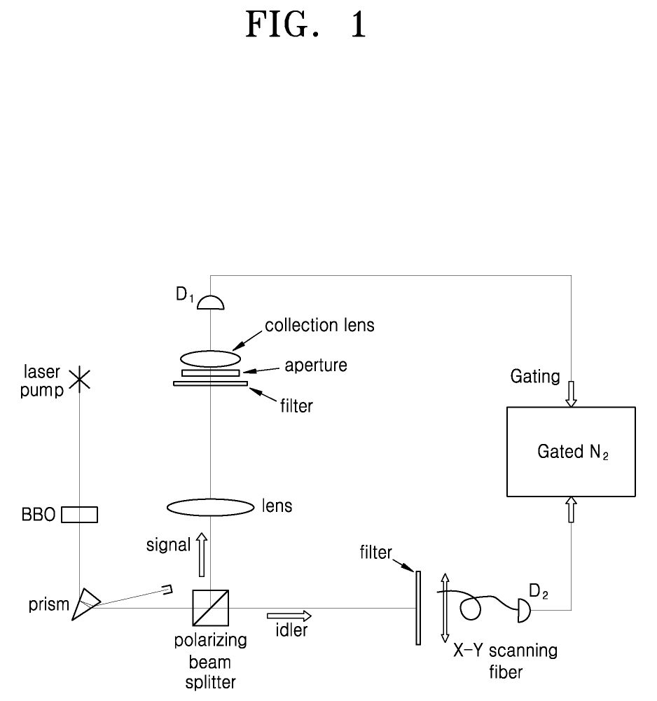

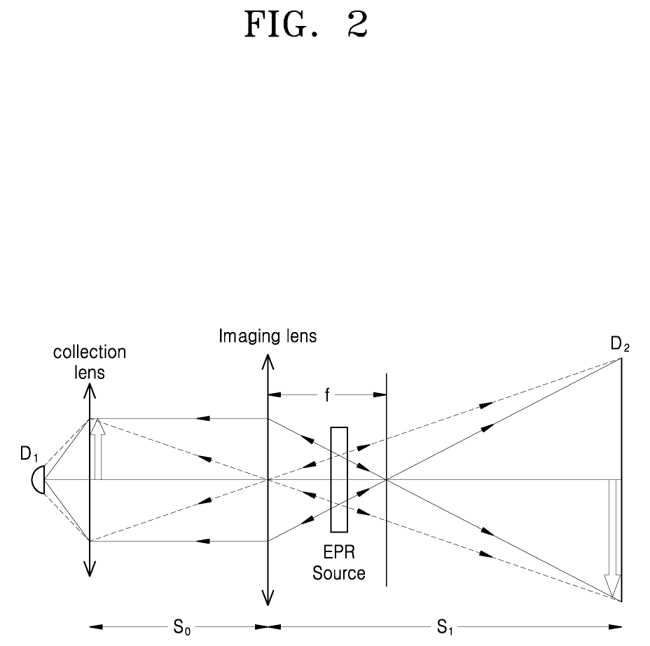

As illustrated in FIG. 3, unlike the configuration of the ghost image experiment conceptual diagram of FIG. 1, an observation target is omitted and each of the detector D1 and the detector D2 is replaced with a charge-coupled device (CCD) sensor (e.g., 2D-CCD).

Because the quantum communication method according to the disclosure is intended to implement quantum communication by using the cross-correlation of spatial information due to photon entanglement of a ghost image, the derivation of actual image information is not required. However, because a second CCD sensor 310 is located instead of the observation target and the detector D1 in a signal path of the quantum communication apparatus, position information of a photon correlated with the relative position of a photon observed by a first CCD sensor 230 may be obtained.

The controller 100 according to an embodiment may include a memory 110, a processor 120, a communication module 130, and a user interface module 140.

The communication module 130 may provide a function for communicating with an external device through a network. For example, a request generated by the processor 120 according to the program code stored in a recording device such as the memory 110 may be transmitted to the external device through the network under control by the communication module 130. Conversely, control signals, commands, content, files, or the like provided from the external device may be received by the controller 100 through the communication module 130 via the network. For example, the control signals or commands of the external device received through the communication module 130 may be transmitted to the processor 120 or the memory 110.

The communication method is not limited thereto and may also include not only a communication method using a communication network (e.g., a mobile communication network, a wired internet, a wireless internet, or a broadcasting network) that the network may include, but also a short-range wireless communication between devices. For example, the network may include one or more of networks such as Personal Area Network (PAN), Local Area Network (LAN), Campus Area Network (CAN), Metropolitan Area Network (MAN), Wide Area Network (WAN), Broadband Network (BBN), and the Internet. Also, the network may include one or more of network topologies including bus networks, star networks, ring networks, mesh networks, star-bus networks, tree or hierarchical networks, and the like but is not limited thereto.

Also, the communication module 130 may communicate with an external server through a network. The communication method is not limited thereto and the network may be a short-range wireless communication network. For example, the network may be a Bluetooth network, a Bluetooth Low Energy (BLE) network, or a WiFi network.

The user interface module 140 may be a unit for interfacing with an input/output device. For example, an input device may include a device such as a keyboard or a mouse, and an output device may include a device such as a display for displaying a communication session of an application. As another example, the user interface module 140 may be a unit for interfacing with a device such as a touch screen in which functions for input and output are integrated into one. More particularly, when the processor 120 processes a command of a computer program loaded in the memory 110, a service screen or content configured by using data provided by an external device may be displayed on a display through the user interface module 140.

The memory 110 may be a computer-readable recording medium and may include a permanent mass storage device such as a random-access memory (RAM), a read-only memory (ROM), and a disk drive. Also, program code for controlling the quantum communication apparatus may be temporarily or permanently stored in the memory 110.

The processor 120 may control an overall operation of the quantum communication apparatus. For example, in order to perform the above operation, the processor 120 may be implemented in a form that selectively includes a processor, an application-specific integrated circuit (ASIC), another chipset, a logic circuit, a register, a communication modem, and/or a data processor that are known in the art. For example, the processor 120 may perform basic arithmetic, logic, and input/output operations and may execute the program code stored in the memory 110. The processor 120 may store data in the memory 110 or load the data stored in the memory 110.

The transmitter 200 may generate a signal photon and an idler photon, which are a pair of photons in a quantum entangled state, transmit the signal photon through a signal path, transmit the idler photon through an idler path, and detect a detection position of the idler photon.

The transmitter 200 may include a photon generator 210, a beam splitter 220, a first CCD sensor 230, and a lens optical unit 240.

The photon generator 210 may generate a signal photon and an idler photon by using a single photon.

The beam splitter 220 may separate the signal photon and the idler photon into the signal path and the idler path respectively.

The first CCD sensor 230 may detect a detection position of the idler photon transmitted through the idler path.

The lens optical unit 240 may form a signal path such that the signal photon of the signal path may be collected by the receiver 300.

The receiver 300 may receive a signal photon transmitted through the signal path and detect a detection position of the signal photon.

The receiver 300 may include the second CCD sensor 310.

The second CCD sensor 310 may detect a detection position of the signal photon transmitted through the signal path.

The controller 100 may perform quantum communication based on detection position data of the idler photon and detection position data of the signal photon.

The controller 100 perform quantum communication based on pattern information of detection position data detected by the first CCD sensor 230 and the second CCD sensor 310 and cryptographic key information corresponding to the pattern information.

The controller 100 may be configured to have a first delay time between photon transmissions in case of normal photon reception according to the pattern information and the cryptographic key information, have a second delay time between photon transmissions in case of abnormal photon reception, and have a third delay time between photon transmissions in case of termination of photon transmission.

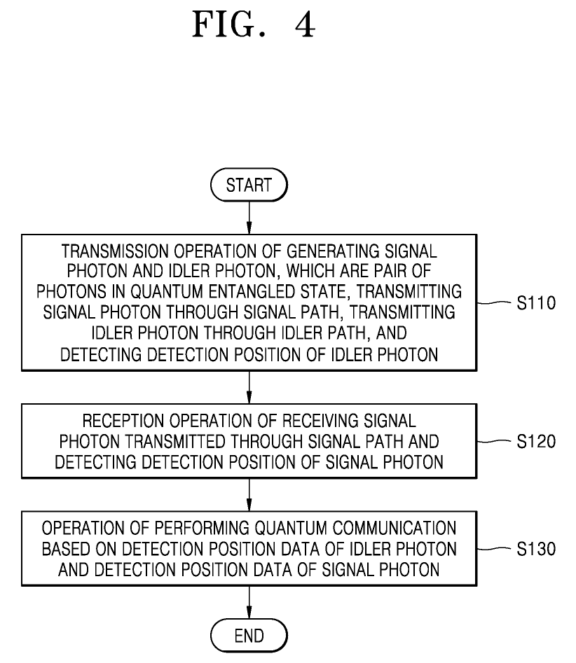

FIG. 4 is a flowchart illustrating a quantum communication method according to an embodiment. For example, the quantum communication method according to an embodiment may be performed by the quantum communication apparatus illustrated in FIG. 3.

Referring to FIG. 4, in operation S110, the quantum communication apparatus according to an embodiment may generate a signal photon and an idler photon, which are a pair of photons in a quantum entangled state, transmit the signal photon through a signal path, transmit the idler photon through an idler path, and detect a detection position of the idler photon. For example, the quantum communication apparatus according to an embodiment may generate a signal photon and an idler photon by using a single photon. Also, the quantum communication apparatus may separate the signal photon and the idler photon into the signal path and the idler path respectively. Also, the quantum communication apparatus may detect a detection position of the idler photon transmitted through the idler path, by using a first CCD sensor. Also, the quantum communication apparatus may form a signal path such that the signal photon may be collected.

In operation S120, the quantum communication apparatus according to an embodiment may receive a signal photon transmitted through the signal path and detect a detection position of the signal photon. For example, the quantum communication apparatus may detect a detection position of the signal photon transmitted through the signal path, by using a second CCD sensor.

In operation S130, the quantum communication apparatus according to an embodiment may perform quantum communication based on detection position data of the idler photon and detection position data of the signal photon. For example, the quantum communication apparatus perform quantum communication based on pattern information of detection position data detected by the first CCD sensor and the second CCD sensor and cryptographic key information corresponding to the pattern information. For example, the quantum communication apparatus may have a first delay time between photon transmissions in case of normal photon reception according to the pattern information and the cryptographic key information. Also, the quantum communication apparatus may have a second delay time between photon transmissions in case of abnormal photon reception. Also, the quantum communication apparatus may have a third delay time between photon transmissions in case of termination of photon transmission.

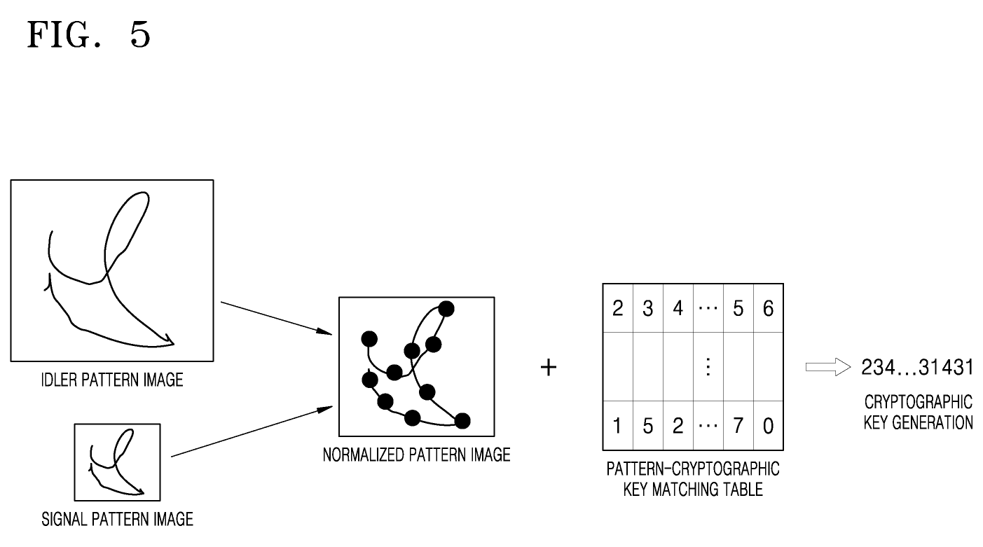

FIG. 5 illustrates a quantum cryptographic key generation method according to an embodiment.

In a quantum cryptogram transmission method according to an embodiment, a quantum cryptographic key may be generated and a quantum cryptogram may be transmitted through Operations 1 to 5 below.

Operation 1: Transmitting, by a quantum communication transmitter, a series of single photons through a signal path.

Operation 2: Identifying, by a quantum communication receiver, the position of each of received single photons to construct a 2D pattern (e.g., the 2D pattern generated by the receiver may have a different size than but may have the same shape as a 2D pattern generated in an idler path, due to the quantum characteristics of photon entanglement).

Operation 3: Generating a cryptographic key by using a predefined pattern-cryptographic key matching table (e.g., using a normalized pattern size).

Operation 4: Transmitting cryptographic key information generated by using the generated cryptographic key from the transmitter to the receiver to check for a disturbance.

Operation 5: Repeating again from Operation 1 when there is an error in the verified quantum cryptogram.

For example, assuming that each of the first CCD sensor and the second CCD sensor is a 2D CCD sensor and has 2×2 pixels (e.g., when different in number from each other, they are processed through a normalization process to be treated as having relatively the same size), the upper/left pixel may be defined as pixel 1, the upper/right pixel as pixel 2, the lower/left pixel as pixel 3, and the lower/right pixel as pixel 4. Also, in the pattern-cryptographic key matching table, pixel 1 may be defined as number 1, pixel 2 as number 2, pixel 3 as number 3, and pixel 4 as number 4.

For example, when a first photon is transmitted from the transmitter and is detected at pixel 2 in the receiver, '2' may be generated. Also, when a second photon is transmitted from the transmitter and is detected at pixel 3 in the receiver, '3' may be generated. Also, when a third photon is transmitted from the transmitter and is detected at pixel 1 in the receiver, '1' may be generated. Also, when a fourth photon is transmitted from the transmitter and is detected at pixel 4 in the receiver, '4' may be generated. Consequently, a cryptographic key '2314' may be generated, and when there is no unusual disturbance during photon transmission, the receiver and the transmitter may generate the same cryptographic key. Subsequently, test pattern data previously defined between the transmitter and the receiver may be transmitted by a data quantum communication transmission method to identify whether the test pattern data is decrypted, to identify whether the cryptographic key has been properly transmitted. Also, when the test pattern data decrypted in the receiver is inconsistent, a cryptographic pattern may be regenerated by performing photon transmission again from the beginning.

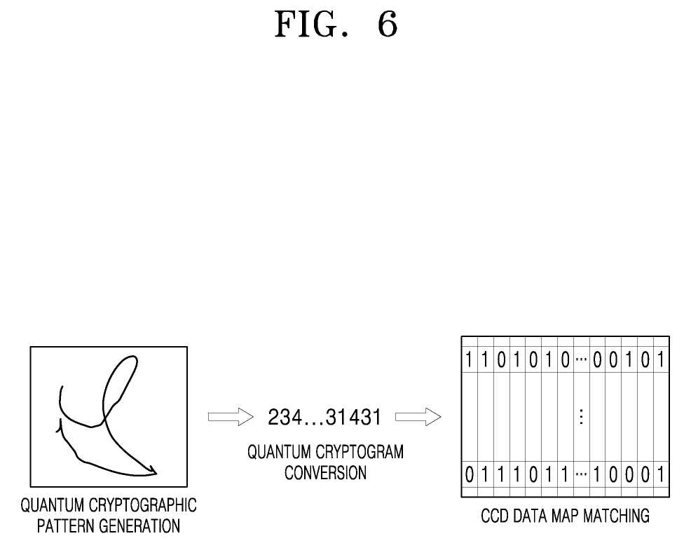

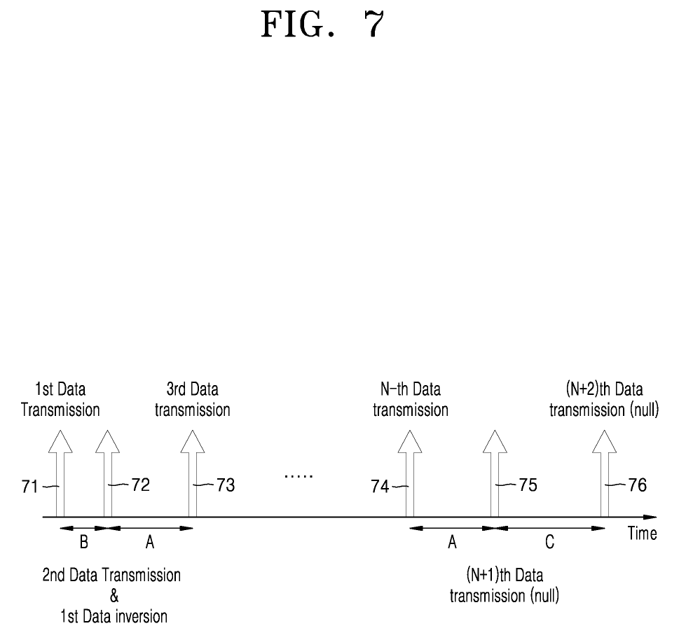

FIG. 6 illustrates a matching relationship between a quantum cryptographic pattern and a CCD data map according to an embodiment. FIG. 7 illustrates an example of a quantum communication method according to an embodiment.

In the quantum communication method according to an embodiment, quantum communication may be performed through Operations 1 to 4 below.

Operation 1: Designing the first CCD sensor and the second CCD sensor to have the same number of cells.

Operation 2: Mutually sharing a quantum cryptogram (transformed from a pattern) by a quantum cryptogram transmission method.

Operation 3: Generating a predefined CCD data map based on the shared quantum cryptogram.

Operation 4: Performing quantum communication of data by using the CCD data map generated in Operation 3.

For example, assuming that each of the first CCD sensor and the second CCD sensor has 2×2 pixels (e.g., when different in number from each other, they are processed through a normalization process to be treated as having relatively the same size), the upper/left pixel may be defined as pixel 1, the upper/right pixel as pixel 2, the lower/left pixel as pixel 3, and the lower/right pixel as pixel 4. Also, in the CCD data map, pixel 1 may be defined as number 1, pixel 2 as number 0, pixel 3 as number 0, and pixel 4 as number 1.

For example, as illustrated in FIG. 7, when the transmitter transmits four pieces of data, when a first photon is transmitted from the transmitter in order to transmit data of '0' (71) and is detected at pixel 1 in the receiver, '1' may be generated. Subsequently, the transmitter may determine that data of '0' has not been properly received and may transmit second data after a delay time B (72). When data is transmitted after a delay time B, the receiver may change '1' to '0' by toggling the immediately previously received data.

When a second photon is transmitted from the transmitter in order to transmit data of '1' (72) and is detected at pixel 4 in the receiver, '1' may be generated. Subsequently, the transmitter may determine that data of '1' has been properly received and may transmit third data after a delay time A (73).

When a third photon is transmitted from the transmitter in order to transmit data of '0' (73) and is detected at pixel 3 in the receiver, '0' may be generated. Subsequently, the transmitter may determine that data of '0' has been properly received and may transmit fourth data after a delay time A (74).

When a fourth photon is transmitted from the transmitter in order to transmit data of '0' (74) and is detected at pixel 3 in the receiver, '0' may be generated. Subsequently, the transmitter may determine that data of '0' has been properly received and may transmit fifth data after a delay time A (75).

When a fifth photon is transmitted from the transmitter in order to transmit data of '1' (75) and is detected at pixel 1 in the receiver, the transmitter may determine that data of '1' has been properly received and may transmit the last photon after a delay time C (76) and terminate data quantum transmission. In this case, the receiver may finally receive data of '0100'.

Also, according to the quantum communication method according to an embodiment, an RF communication method may be used to identify a cyclic redundancy check (CRC) of the finally received data to finally identify whether there is any error or disturbance in communication.

For example, a quantum cryptogram may be randomly generated, and a CCD data map (e.g., including a binary number), which is predefined or calculated by an algorithm, may be generated according to the generated quantum cipher (e.g., including a decimal number).

For example, the number of the quantum cryptogram may be converted into a binary number and repeatedly mapped to a string obtained by converting two-dimensional (2D) pixels of the CCD into one-dimensional (1D) pixels. Also, the 1D string may be converted back into 2D and used as a CCD data map.

In the quantum communication method according to an embodiment, data may be transmitted by quantum communication through Operations 1 to 5 below.

Operation 1: Designing an optical unit such that D1-CCD and D2-CCD have the same number of cells.

Operation 2: Predefining such that a value of 1 or 0 is uniformly distributed in each pixel of the CCD (e.g., generation of a CCD data map).

Operation 3: Transmitting 1-bit single photon information from the transmitter to the receiver to correspond to the CCD data map (e.g., due to the entanglement properties of photons, the same data map value may be simultaneously and remotely identified by the first CCD sensor and the second CCD sensor, and in case of a disturbance, the probability of mutual positions being equal to each other may decrease to a probability of 1/(the number of all CCD pixels)).

For example, the data security issue according to the disclosure may be related to an external disturbance (a type of jamming or spoofing) that affects the path of photons transmitted between the transmitter and the receiver.

Operation 4: When the identified 1-bit value of the CCD data map matches the bit to be transmitted, the second bit information may be transmitted after a time delay A, and when it does not match, the second data may be transmitted after a time delay B to invert the bit information of the first data.

Operation 5: the last (n+1)th/(n+2)th data is null data, the validity of the n-th data is represented by the time delay during transmission, and communication is terminated by transmitting the (n+2)th data after a time delay C following the (n+1)th data.

The quantum communication method using ghost images according to an embodiment may be distinguished from the existing quantum communication method in that an increase in the number of CCD pixels used and an improvement in optical resolution are proportional to an increase in communication data security, and may suggest the possibility of further improving data security through an improved design of a CCD and an optical structure in comparison with the existing quantum communication (single-photon communication using photon polarization information).

The apparatuses and/or systems described above may be implemented as hardware components, software components, and/or a combination of hardware components and software components. For example, the apparatuses and components described in the embodiments may be implemented by using one or more general-purpose computers or special-purpose computers such as processors, controllers, arithmetic logic units (ALUs), digital signal processors, microcomputers, field programmable gate arrays (FPAs), programmable logic units (PLUs), microprocessors, or any other apparatuses capable of executing and responding to instructions. The processor may execute an operating system (OS) and one or more software applications that are executed on the OS. Also, the processor may access, store, operate, process, and generate data in response to execution of the software. For convenience of understanding, the processor may be described as being used singly; however, those of ordinary skill in the art will understand that the processor may include a plurality of processing elements and/or a plurality of types of processing elements. For example, the processor may include a plurality of processors or one processor and one controller. Also, other processing configurations such as parallel processors may also be possible.

The software may include computer programs, code, instructions, or a combination of one or more thereof and may configure the processor to operate as desired or may instruct the processor independently or collectively. The software and data may be stored on one or more computer-readable recording mediums.

The method according to an embodiment may be embodied in the form of program instructions executable through various computer means, which may be recorded on a computer-readable recording medium. The computer-readable recording medium may include program instructions, data files, and data structures either alone or in combination. The program instructions recorded on the computer-readable recording medium may be especially designed and configured for the embodiment or may be already known and available to those of ordinary skill in computer software. Examples of the computer-readable recording medium include magnetic media such as hard disks, floppy disks, and magnetic tapes, optical media such as CD-ROMs and DVDs, magneto-optical media such as floptical disks, and hardware devices such as ROMs and flash memories that are specially configured to store and execute program instructions. Examples of the program instructions include not only machine language codes such as those generated by compilers, but also high-level language codes that may be executed by computers by using interpreters or the like. The hardware device described above may be configured to operate as one or more software modules in order to perform the operation of an embodiment, and vice versa.

As described above, according to an embodiment, provided are a quantum communication apparatus and method using ghost images, which may improve the security of communication data by applying the ghost imaging technology to the field of information and communication. However, the scope of the disclosure is not limited to these effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A quantum communication apparatus comprising:
a transmitter configured to generate a pair of photons in a quantum entangled state, the pair of photons being a signal photon and an idler photon, transmit the signal photon through a signal path, transmit the idler photon through an idler path, and detect a detection position of the idler photon;
a receiver configured to receive the signal photon transmitted through the signal path and detect a detection position of the signal photon; and
a controller configured to perform quantum communication based on detection position data of the idler photon and detection position data of the signal photon.

2. The quantum communication apparatus of claim 1, wherein the transmitter comprises:
a photon generator configured to generate the signal photon and the idler photon by using a single photon;
a beam splitter configured to split the signal photon and the idler photon into a signal path and an idler path respectively;
a first charge-coupled device (CCD) sensor configured to detect a detection position of the idler photon transmitted through the idler path; and
a lens optical unit configured to form the signal path such that the signal photon of the signal path is collected by the receiver.

3. The quantum communication apparatus of claim 2, wherein the receiver comprises a second CCD sensor configured to detect the detection position of the signal photon transmitted through the signal path.

4. The quantum communication apparatus of claim 3, wherein the controller is configured to perform quantum communication based on pattern information of detection position data detected by the first CCD sensor and the second CCD sensor and cryptographic key information corresponding to the pattern information.

5. The quantum communication apparatus of claim 4, wherein the controller is configured to have a first delay time between photon transmissions in a case of normal reception of photons according to the pattern information and the cryptographic key information, have a second delay time between photon transmissions in a case of abnormal reception of photons, and have a third delay time between photon transmissions in a case of termination of transmission of photons.

6. A quantum communication method comprising:
a transmission operation of generating a pair of photons in a quantum entangled state, the pair of photons being a signal photon and an idler photon, transmitting the signal photon through a signal path, transmitting the idler photon through an idler path, and detecting a detection position of the idler photon;
a reception operation of receiving the signal photon transmitted through the signal path and detecting a detection position of the signal photon; and
an operation of performing quantum communication based on detection position data of the idler photon and detection position data of the signal photon.

7. The quantum communication method of claim 6, wherein the transmission operation comprises:
an operation of generating a signal photon and an idler photon by using a single photon;
an operation of splitting the signal photon and the idler photon into a signal path and an idler path respectively;
an operation of detecting a detection position of the idler photon transmitted through the idler path, by using a first charge-coupled device (CCD) sensor; and
an operation of forming the signal path such that the signal photon is collected.

8. The quantum communication method of claim 7, wherein the reception operation comprises an operation of detecting the detection position of the signal photon transmitted through the signal path, by using a second CCD sensor.

9. The quantum communication method of claim 8, wherein the operation of performing quantum communication comprises an operation of performing quantum communication based on pattern information of detection position data detected by the first CCD sensor and the second CCD sensor and cryptographic key information corresponding to the pattern information.

10. The quantum communication method of claim 9, wherein the operation of performing quantum communication comprises:
an operation of having a first delay time between photon transmissions in a case of normal reception of photons according to the pattern information and the cryptographic key information;
an operation of having a second delay time between photon transmissions in a case of abnormal reception of photons; and
an operation of having a third delay time between photon transmissions in a case of termination of transmission of photons.

11. A computer program stored in a computer-readable recording medium to execute the quantum communication method of claim 6 by using a computing device.
